(19) United States
(12) Patent Application Publication
(10) Pub. No.: US 2020/0391145 A1
(43) Pub. Date: Dec. 17, 2020

(54) Filter Element of a Filter for Fluid, Discharge Closure Element for a Discharge Opening of a Filter Housing, and Filter

(71) Applicant: MANN+HUMMEL GmbH, Ludwigsburg (DE)

(72) Inventor: Herbert Jainek, Heilbronn (DE)

(21) Appl. No.: 16/907,979

(22) Filed: Jun. 22, 2020

Related U.S. Application Data
(63) Continuation of application No. PCT/EP2018/083454, filed on Dec. 4, 2018.

(30) Foreign Application Priority Data
Dec. 22, 2017 (DE) 102017012016.1

(51) Int. Cl. B01D 35/16; B01D 35/30; B01D 35/00; B01D 29/15

(52) U.S. Cl. CPC B01D 35/16; B01D 35/30; B01D 35/005; B01D 29/15; F01M 11/04; B01D 2201/304; B01D 2201/342; B01D 2201/347; B01D 2201/291

(57) ABSTRACT

A filter element of a filter for liquid has a filter medium surrounding an element interior circumferentially continuously relative to a virtual axis. An end body is connected to an axial end face of the filter element and has a filter element drainage opening surrounding the virtual axis and connected to the element interior. The end body has a filter element sealing surface or filter element seal surface of a filter element sealing device which surrounds the filter element drainage opening circumferentially continuously and closes the filter element drainage opening when the filter element is mounted in the filter. A seal of the filter element sealing device that is circumferentially continuous relative to the virtual axis is fastened at the filter element. A discharge closure element closes the discharge opening of the filter housing of the filter and has a sealing surface that close the filter element drainage opening.

### CROSS-REFERENCE TO RELATED APPLICATIONS

This application is a continuation application of international application No. PCT/EP2018/083454 having an international filing date of 4 Dec. 2018 and designating the United States, the international application claiming a priority date of 22 Dec. 2017 based on prior filed German patent application No. 10 2017 012 016.1, the entire contents of the aforesaid international application and the aforesaid German patent application being incorporated herein by reference.

### TECHNICAL FIELD

The invention concerns a filter element of a filter for liquid, in particular oil or fuel, in particular of an internal combustion engine, in particular of a motor vehicle, with at least one filter medium, which surrounds circumferentially continuously an element interior relative to a virtual axis and which is connected at least at one end face that is axial relative to the axis with an end body, wherein the end body comprises a filter element drainage opening surrounding the axis and connected to the element interior and at least one filter element sealing surface or filter element seal surface of a filter element sealing device, which surrounds circumferentially continuously the filter element drainage opening and with which the filter element drainage opening can be closed when the filter is assembled.

Moreover, the invention concerns a discharge closure element for at least one discharge opening of a filter housing of a filter for liquid, in particular oil or fuel, in particular of an internal combustion engine, in particular of a motor vehicle, that comprises at least one sealing surface of a filter element sealing device for closing a filter element drainage opening of a filter element of the filter which surrounds circumferentially continuously a virtual axis, wherein the discharge closure element can be connected to the filter element and/or to the filter housing or separated therefrom by means of a rotary and/or insertion movement relative to the axis.

In addition, the invention concerns a filter for liquid, in particular oil or fuel, in particular of an internal combustion engine, in particular of a motor vehicle, with at least one filter housing in which a filter element is arranged, wherein the filter element comprises at least one filter element drainage opening and the filter housing comprises a discharge opening for liquid which are closed by a discharge closure element.

### BACKGROUND OF THE INVENTION

WO 2013/178680 A1 discloses a filter device, in particular for a motor vehicle, with a filter housing, with a housing cover fastened at the filter housing which comprises a housing cover drainage opening, with a filter element connectable or connected to the housing cover which comprises a filter element drainage opening and, in a state mounted in the filter housing, separates a raw side from a clean side in the filter housing, with a closure element connectable or connected to the housing cover, which closes, in a state attached to the housing cover, the housing cover drainage opening as well as the filter element drainage opening. The closure element comprises a radial seal by means of which the closure element, in the state attached to the housing cover, seals in the filter element drainage opening the raw side against the clean side.

### SUMMARY OF THE INVENTION

The invention has the object to design a filter element, a discharge closure element, and a filter of the aforementioned kind such that a seal of the filter element sealing device can be exchanged in a simple way.

The object is solved according to the invention for the filter element in that the filter element sealing device comprises at least one seal that is circumferentially continuous relative to the axis and that is fastened on the part of the filter element.

According to the invention, the at least one seal is thus connected to the filter element. In this way, the at least one seal can be pre-manufactured and, as needed, exchanged together with the filter element.

Advantageously, the at least one seal can be elastic. In this way, the seal can be installed in a position-tolerant way. Advantageously, the at least one seal can be comprised of an elastomer.

In an advantageous embodiment, at least one seal can act to seal radially and/or axially relative to the axis. In this context, the at least one seal can act to seal either radially or axially or radially as well as axially. Radially acting seals can be realized as much as possible independent of an axial mounting force between the components of the filter. Exclusively axially acting seals can be loaded, depending on a mounting force between the filter parts, with a corresponding increased seal pressure so that the sealing action can be improved.

In a further advantageous embodiment, at least one seal can be arranged on a sleeve-type positioning element which extends on the exterior side of the end body axially relative to the axis and which forms at least partially the filter element drainage opening. In this way, the at least one seal can be secured in a stable way. Moreover, a single component, namely the positioning element, can serve for positioning in particular the filter element relative to the housing and/or relative to a corresponding discharge closure element for at least one discharge opening and also as a holding element for the at least one seal.

In a further advantageous embodiment, at least one seal can be arranged radially outwardly relative to the axis on the sleeve-type positioning element. In this way, the interior of the positioning element cannot be limited by the at least one seal.

Advantageously, the positioning element can comprise at its radially outer circumferential side at least one receptacle, in particular a circumferential sealing groove, for the at least one seal. In the receptacle, the at least one seal can be secured and positioned captively.

Advantageously, the positioning element can comprise at its radially outer circumferential side a sealing surface extending circumferentially relative to the axis for supporting the at least one seal. In this way, the seal can act to seal in radial direction relative to the positioning element.

Alternatively, the positioning element at the radially outer circumferential side can comprise circumferentially interrupted positioning surfaces. In this way, the at least one seal can rest at the radially outer circumferential side of the positioning element but a radial sealing action can be avoided. In this case, the at least one seal can be designed such that it is acting exclusively in axial direction.

In a further embodiment, an end body of the filter element comprises an additional sleeve. This sleeve is fixedly connected to the end body, for example, locked, welded, glued or fixedly connected in a different way. Such an embodiment facilitates the configuration of the end body and of the required sealing and seal surfaces so as to be appropriate for mold tooling, in particular in an embodiment produced by plastics injection molding. In this context, the additional sleeve can be inserted in axial direction into the end body of the filter element. Advantageously, the additional sleeve projects inwardly in the filter element in axial direction past the end body. In this way, an abutment, for example, with a rim that projects in axial direction radially past the opening, can be provided that enables a fixed connection of the sleeve with the end body. The additional sleeve can comprise a circumferentially continuous sealing groove in which a filter element seal, for example, an O-ring seal, is received and, when the filter is mounted, rests so as to seal in radial direction against the sealing surface, embodied by the discharge closure element, and seals the interior of the filter element relative to the exterior of the filter element. The sleeve can be embodied in an advantageous embodiment as a sleeve-shaped coaxial positioning element. The end body can be recessed axially into the filter element in a space-saving configuration.

Advantageously, the positioning element can be surrounded radially outwardly by an axially oriented sealing surface for the at least one seal. With the axially oriented sealing surface, at least one seal can interact in an axially sealing way.

Moreover, the technical object is solved according to the invention for the discharge closure element in that the at least one sealing surface is freely accessible in an axial direction via an end face that is axial relative to the axis and that, for closing the at least one discharge opening, is facing, or can be oriented to face, the interior of the filter housing. In this way, a corresponding seal of the filter element sealing device can be brought into engagement via the axially oppositely positioned side, i.e., facing the interior of the filter housing, in axial direction with the at least one sealing surface of the discharge closure element. Correspondingly, the sealing surface can also be separate from the seal. In this way, the discharge closure element with the corresponding rotary and/or insertion movement can be moved away from the filter element so that the filter element drainage opening and the discharge opening can be released.

In an advantageous embodiment, the at least one sealing surface can be radially and/or axially oriented relative to the axis. In this way, in connection with the corresponding seal, a corresponding exclusively radial, exclusively axial, or radial and axial sealing action can be achieved.

In a further advantageous embodiment, the at least one sealing surface, relative to the axis, can be arranged radially inwardly or radially outwardly of a centering element which can interact with a positioning element of the filter element. The centering element in this context can be designed as a centering projection or centering opening. A centering projection can engage a corresponding opening, in particular the filter element drainage opening, of the positioning element of the filter element for positioning in particular the filter element. An in particular sleeve-shaped or pin-shaped positioning element of the filter element can engage a centering opening for positioning.

In case of a centering element in the form of a centering opening, the sealing surface can be arranged at the circumferential side of the centering opening and oriented radially inwardly.

In case of a centering element in the form of a centering projection, the sealing surface can surround the centering projection radially outwardly.

In addition, the technical object is solved for the filter in that a filter element according to the invention is arranged in the filter housing and the filter element drainage opening as well as the discharge opening are closed by a discharge closure element according to the invention.

In an advantageous embodiment, the positioning element and the discharge closure element are arranged to overlap in axial direction in such a way that at least one region of the positioning element surrounds circumferentially at least a region of the discharge closure element or at least a region of the discharge closure element surrounds at least a region of the positioning element.

In other respects, the features and advantages disclosed in connection with the filter element according to the invention, the discharge drainage element according to the invention, and the filter according to the invention and their respective advantageous embodiments apply correspondingly among each other and vice versa. The individual features and advantages can, of course, be combined among each other, wherein additional advantageous effects may result that go beyond the sum of the individual effects.

### BRIEF DESCRIPTION OF THE DRAWINGS

Further advantages, features, and details of the invention result from the following description in which embodiments of the invention will be explained in more detail with the aid of the drawing. A person of skill in the art will consider the features disclosed in combination in the drawing, the description, and the claims expediently also individually and combine them to expedient further combinations.

FIG. 1 shows a longitudinal section of the filter for liquid of an internal combustion engine of a motor vehicle according to a first embodiment.

FIG. 2 shows an isometric detail view of a housing cover of the filter of FIG. 1 in the region of the discharge opening for the liquid.

FIG. 3 shows an isometric detail view of a filter element of the filter of FIG. 1 in the region of a filter element drainage opening for the liquid.

FIG. 4 shows a longitudinal section of a partial region of a liquid filter according to a second embodiment.

FIG. 5 shows a longitudinal section of a partial region of a liquid filter according to a third embodiment.

In the Figures, same components are provided with same reference characters.

### DESCRIPTION OF PREFERRED EMBODIMENTS

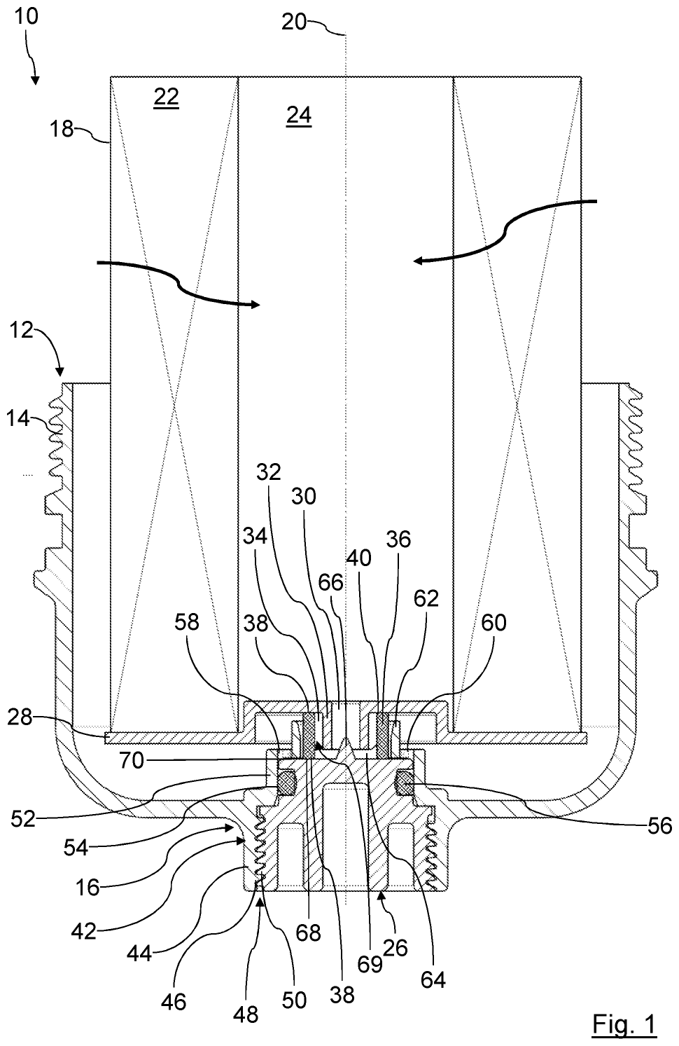

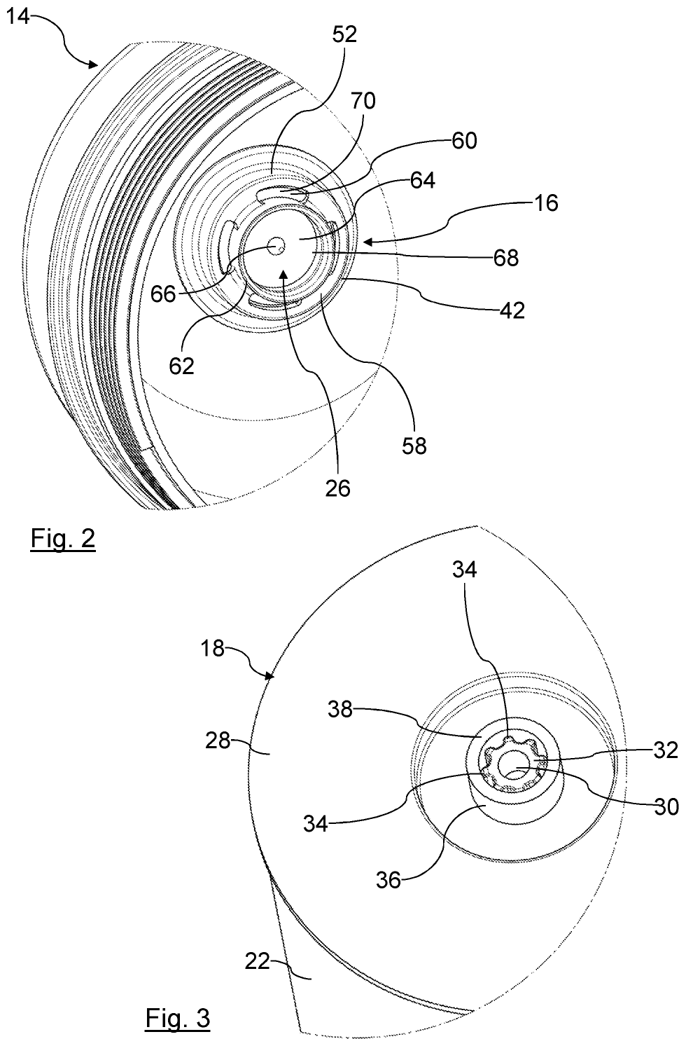

In FIGS. 1 to 3, a filter 10 for liquid, for example, oil or fuel, of an internal combustion engine of a motor vehicle according to a first embodiment is illustrated in a longitudinal section and in detail views. The filter 10 is arranged in a liquid circuit, for example, a motor oil circuit or a fuel circuit, of the internal combustion engine.

The filter 10 comprises a filter housing 12 of which only the housing cover 14 is illustrated in FIG. 1. The housing cover 14 is screwed, spatially at the bottom, into a main housing, not illustrated, of the filter housing 12. The filter housing 12 comprises a liquid inlet for the liquid to be purified and a liquid outlet for purified liquid which are both not illustrated in the Figure.

Moreover, the filter housing 12 comprises, at the spatially lowest location of the housing cover 14, a drainage assembly 16 through which the liquid can be drained from the interior of the filter housing 12, for example, for servicing purposes. In the filter housing 12, a filter element 18 embodied as a round filter element is arranged such that it separates the liquid inlet from the liquid outlet. The filter element 18 is connected to the housing cover 14 so as to be separable in a way not of interest in this context.

The filter element 18 comprises a filter medium 22 which, relative to a virtual axis 20, is circumferentially continuous and which surrounds an element interior 24. In operation of the filter 10, the filter element 18 is flowed through by the liquid in radial direction from the exterior to the interior so that the element interior 24 is the clean side of the filter element 18 and the interior of the filter housing 12 surrounding the filter element 18 is the raw side.

When in the following “axial”, “radial”, “coaxial”, “circumferential” or the like is mentioned, this relates to the axis 20, if nothing else is mentioned. In the illustrated embodiment, the axis 20 coincides with an element axis of the filter element 18, an installation axis of the filter element 18 in the housing cover 14, a housing axis of the filter housing 12, and a connecting axis of a discharge closure element 26 of the discharge assembly 16 with the housing cover 14. Therefore, for simplification, in the following reference is being had to axis 20, respectively. It is understood that in case of demounted filter 10, the axis 20 corresponds to the respective axes mentioned above.

An end disc 28 is fastened at an end face of the filter element 18, arranged at the bottom in FIG. 1 and facing the discharge assembly 16. The end disc 28 extends across the entire end face of the filter element 18. In the region of the element interior 24, the end disc 28 is axially stepped toward the element interior 24. Here, the end disc 28 comprises a coaxial filter element drainage opening 30.

The filter element drainage opening 30 is formed in a positioning element 32 at the exterior side of the end disc 28 facing away axially from the element interior 24.

The positioning element 32 has the shape of a sleeve which is of a circular cylindrical shape at its radially inner circumferential side. At the radially outer circumferential side, the positioning element 32 is toothed and forms thus radially outwardly a plurality of circumferentially spaced apart positioning sections 34 for a filter element seal 36. The positioning sections 34 extend parallel to the axis 20, respectively.

The filter element seal 36 is designed as a sleeve in the form of a circular hollow cylinder which is coaxially arranged. With its radially inner circumferential side, the filter element seal 36 is resting with circumferential interruptions at the respective positioning sections 34, without acting to seal radially, and is positioned in this way.

At it's axially oppositely positioned end faces, the filter element seal 36 comprises respectively a filter element sealing surface 38. The filter element sealing surfaces 38 are exclusively axially oriented, respectively. The filter element seal 36 comprises therefore no sealing surface acting in radial direction.

The filter element seal 36 projects past the positioning element 32 in axial direction. The filter element seal 36 is made of an elastomer and is elastic in axial direction.

With its filter element seal surface 38 which is facing axially the element interior 24, the filter element seal 36 is resting, seal-tightly acting in axial direction, at a filter element sealing surface 40. The filter element sealing surface 40 surrounds circumferentially continuously the positioning element 32 radially outwardly at the exterior side of the end disc 28, wherein the exterior side is axially facing away from the element interior 24. The filter element sealing surface 40 is also oriented exclusively in axial direction.

The discharge assembly 16 comprises the discharge closure element 26 and a receptacle 42 for the discharge closure element 26 which is located in the spatially lower part of the housing cover 14. The receptacle 42 as a whole is formed as one piece together with the housing cover 14.

The receptacle 42 comprises a coaxial connecting section 44 in the form of a circular cylindrical sleeve at the outer side of the housing cover 14. At its radially inner circumferential side, the connecting section 44 comprises an inner thread 46 of a screw connection 48 which interacts with a corresponding outer thread 50 at the radially outer circumferential side of the discharge closure element 26.

At the inner side of the housing cover 14, which is axially facing the filter element 18, the receptacle 42 comprises a coaxial sealing section 52 in the form of a hollow circular cylinder. The sealing section 52 forms at its radial inner circumferential side an environmental sealing surface 54 which is oriented radially inwardly. At the environmental sealing surface 54, an environmental sealing ring 56 is resting so as to act seal-tightly in radial direction. The environmental sealing ring 56 is arranged in a sealing groove in the radially outer circumferential side of the discharge closure element 26.

At the side which is axially facing away from the bottom of the housing cover 14, the sealing section 52 is bent by 90° in radial direction inwardly and forms there an end wall 58. A plurality of radially outer discharge openings 60 are arranged circumferentially distributed in the end wall 58.

Radially inside the radially outer discharge openings 60, the end wall 58 is bent by 90° from the bottom of the housing cover 14 and passes into a separation section 62. The separation section 62 has the shape of a coaxial hollow circular cylinder. The separation section 62 forms thus a circumferentially continuous separation wall. The separation section 62 surrounds a coaxial radially inner discharge opening 64. The separation section 62 separates in this way the radially outer discharge openings 60 from the radially inner discharge opening 64.

In the region of its rim axially facing away from the end wall 58, the separation section 62 is widened in a funnel shape at the radial inner circumferential side. An axial expansion of the separation section 62 is smaller than an axial expansion of the filter element seal 36 in the relaxed state. When axially compressing the filter element seal 36, the separation section 62 can serve as a stop. An inner diameter of the separation section 62 is larger than an outer diameter of the filter element seal 36. When the filter element 18 is mounted, the separation section 62 surrounds the filter element seal 36 without contacting it. In this way, no radial sealing action between the separation section 62 and the filter element seal 36 is taking place.

The end face of the discharge closure element 26 which is axially facing the interior of the filter housing 12 extends planar and perpendicularly to the axis 20. At its center, the end face comprises a conical coaxial centering element 66. The maximum outer diameter of the centering element 66 is smaller than the inner diameter of the filter element drainage opening 30. The centering element 66 can thus engage the filter element drainage opening 30 in order to center the filter element 18 correspondingly.

Radially outwardly of the centering element 66, the end face of the discharge closure element 26 forms a circumferentially continuous sealing surface 68. The sealing surface 68 corresponds in its diameter and its radial expansion to the corresponding facing spatially lower filter element seal surface 38 of the filter element seal 36. The sealing surface 68 is exclusively oriented in axial direction. When the filter 10 is mounted, the filter element seal surface 38 of the filter element seal 36 is positioned at the sealing surface 68 so as to act sealingly exclusively in axial direction.

The filter element seal 36, the filter element seal surface 38, the filter element sealing surface 40, and the sealing surface 68 form a filter element sealing device 69.

Radially outwardly of the sealing surface 68, the end face of the discharge closure element 26 forms an annular cover surface 70 with which, when the filter 10 is mounted, the radially outer discharge openings 60 can be covered and closed.

A radially outer diameter of the end face of the discharge closure element 26 corresponds to a radial inner diameter of the sealing section 52 of the receptacle 42.

With the filter element seal 36, the clean side of the filter element 18 is separated from the raw side. The separation section 62 in combination with the labyrinth-type arrangement of the recess of the end disc 28 prevents that coarse dirt, for example, chips, can reach from the raw side the region of the filter element seal 36 and impair its sealing action.

For draining the liquid from the filter 10, for example, for servicing purposes, the discharge closure element 26 is unscrewed from the receptacle 42. In doing so, the filter element seal 36 at the side which is facing the sealing surface 68 opens the connection between the filter element drainage opening 30 and the radially inner discharge opening 64 so that liquid can drain from the clean side.

Also, the cover surface 70 releases the radially outer discharge openings 60 so that the liquid from the raw side can drain through the radially outer discharge openings 60.

The positioning element 32 and the discharge closure element 26 with the separation section 62 are arranged so as to overlap in axial direction in the illustrated embodiment. A region of the discharge closure element 62, in the form of the separation section 62, surrounds a region of the positioning element 32. The positioning element 32 dips in the region of the separation section 62 at least partially into the discharge closure element 62 radially surrounding the positioning element 32.

For exchange of the filter element 18, the housing cover 14 is unscrewed from the housing base member. Subsequently, the filter element 18 together with the filter element seal 36 can be pulled out of the housing cover 14 in axial direction and exchanged.

The assembly of the filter 10 is realized in reverse order.

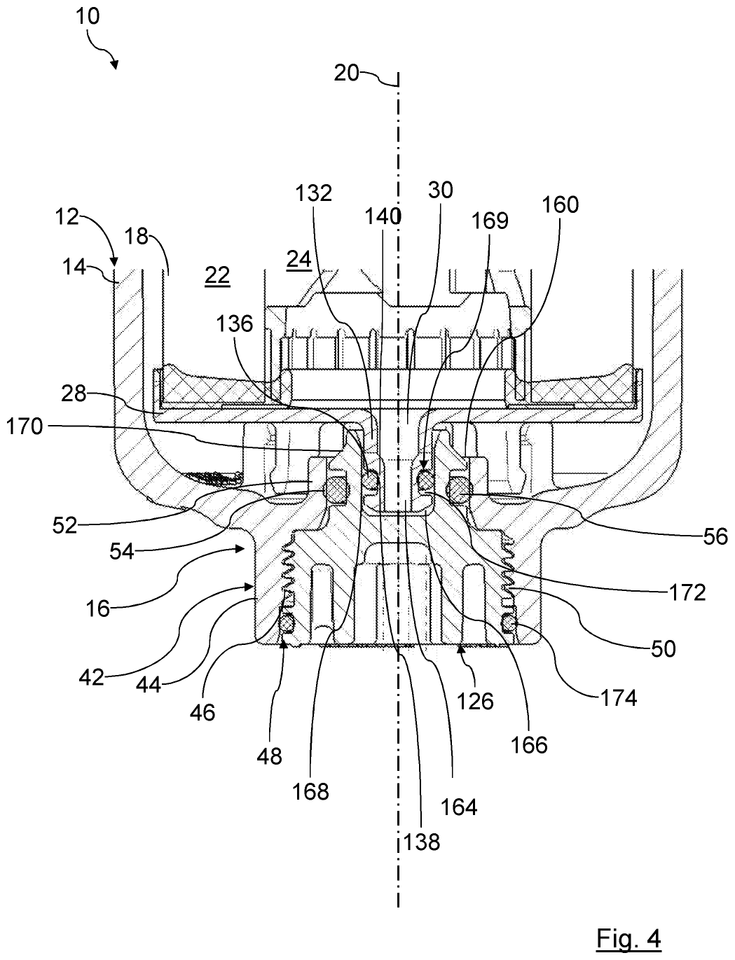

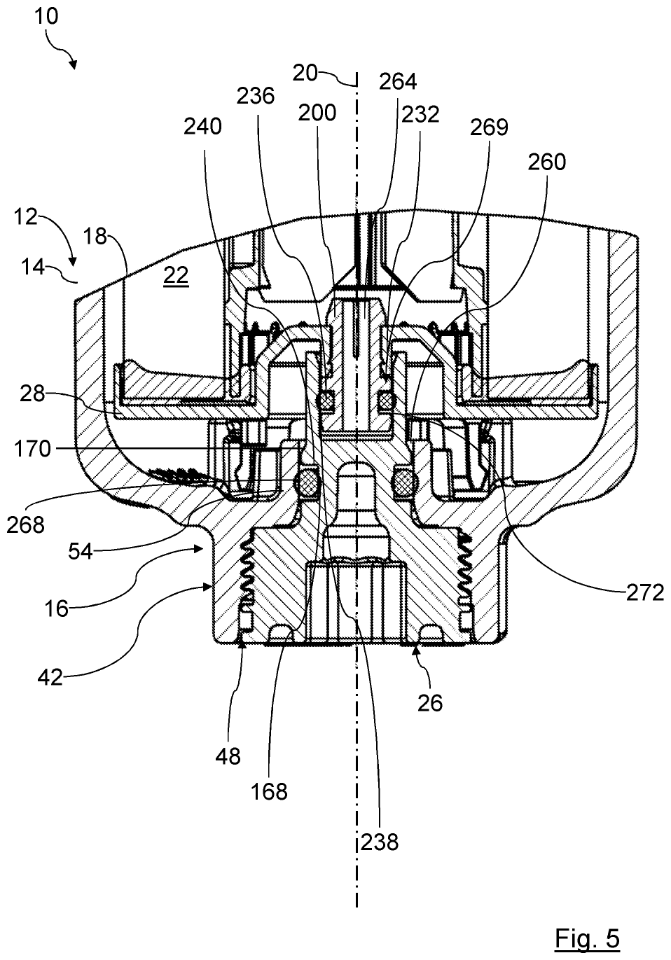

In FIG. 4, a filter 10 according to a second embodiment is illustrated. Those elements which are similar to those of the first embodiment of FIGS. 1 to 3 are provided with the same reference characters.

The second embodiment differs from the first embodiment in that a filter element seal 136 in the form of an O-ring seal is acting to seal in radial direction. The filter element seal 136 is arranged in a circumferentially continuous sealing groove 172 at a radially outer circumferential side of a sleeve-shaped coaxial positioning element 132. The positioning element 132 comprises, in contrast to the positioning element 32 of the first embodiment, no interrupted positioning sections.

A base of the sealing groove 172 forms a radially oriented filter element sealing surface 140. The corresponding radially inner circumferential side of the filter element seal 136 forms a radially inner seal surface 138. The radially inner filter element seal surface 138 is radially oriented and rests in radial direction seal-tightly against the filter element sealing surface 140.

At the end face which is axially facing the filter element 18, the discharge closure element 126 comprises in the sealing section 52 a centering element 166 in the form of a coaxial circular cylindrical centering opening. In the region of its open side which is facing the filter element 18, the centering element 166 is widened in a funnel shape.

The radially inner circumferential side of the sealing section 52 which surrounds the centering element 166 forms a sealing surface 168. The sealing surface 168 is oriented radially inwardly. The radially outer filter element seal surface 138 which is located at the radially outer circumferential side of the filter element seal 136 is resting against the sealing surface 168 so as to act sealingly in radial direction.

The filter element seal 136, the filter element seal surfaces 138, the filter element sealing surface 140, and the sealing surface 168 form a filter element sealing device 169.

An outer diameter of the positioning element 132 corresponds approximately to the diameter of the centering element 166. The centering element 166 extends in axial direction to the level of the circumferential groove with the environmental sealing ring 56.

The end wall 58 and the separation section 62 according to the first embodiment are not provided in the receptacle 42 of the housing cover 14 according to the second embodiment. Instead, a radially outer discharge opening 160 extends continuously circumferentially and is separated by the positioning element 132 from a radially inner discharge opening 164. With removed filter element 18 and removed discharge closure element 126, the radially outer discharge opening 160 and the radially inner discharge opening 164 form a single continuous opening.

With mounted discharge closure element 126, the radially outer discharge opening 160 is closed by a circumferentially continuous slanted cover surface 170. Cover surface 170 is arranged at the radially outer circumferential side of the discharge closure element 126. The cover surface 170 is located, viewed in axial direction, between the end face of the discharge closure element 126 which is facing the filter element and that of the circumferential groove with the circumferential sealing ring 56. The receptacle 42 for the discharge closure element 126 is formed at least radially inwardly of a coaxially cylindrical shape at the side which is facing the interior of the filter housing 12.

Optionally, the discharge closure element 126 comprises an outer seal 174 in the form of a coaxial O-ring seal at the side of the outer thread 50 which is axially facing away from the circumferential groove with the environmental sealing ring 56. The outer seal 174 is arranged in a corresponding circumferentially continuous sealing groove in the radially outer circumferential side of the discharge closure element 126. The outer sealing ring 174 seals in radial direction against a corresponding sealing surface at the radially inner side of the connecting section 44 relative to the environment. When mounting the discharge closure element 126 for the first time in the housing 12, the outer sealing ring 174 can be omitted. Only after removing the discharge closure element 26 for the first time and subsequently screwing it in again, optionally the outer sealing ring 174 can be used additionally in order to seal the screw connection 48 relative to the environment in a better way.

In FIG. 5, a filter 10 according to a third embodiment is illustrated. Those elements which are similar to those of the first embodiment of FIGS. 1 to 3 are provided with the same reference characters, similar elements are provided with a reference number raised by 200.

The third embodiment differs from the second embodiment in that an end body 28 of the filter element 18 comprises an additional sleeve 200. This sleeve 200 is fixedly connected to the end body 28, for example, locked, and forms a discharge opening 264.

A filter element seal 236 in the form of an O-ring seal is received in the sleeve 200 and acts in radial direction. Due to the separate manufacture of the sleeve 200, the filter element 12, in particular the end body 28, can be produced in a simpler and more beneficial way because the end body 28 can be produced in a removal direction from the mold, for example, by injection molding.

A filter element seal 236 is arranged in a circumferentially continuous sealing groove 277 at a radially outer circumferential side of the sleeve 200 wherein the sleeve 200 is embodied as a sleeve-shaped coaxial positioning element 232. The positioning element 232 comprises no interrupted positioning sections, in contrast to the positioning element 32 of the first embodiment. The corresponding inner circumferential side of the filter element seal 236 forms a radial inner seal surface 238.

The end body can be recessed in a space-saving configuration axially into the filter element 18.

Centering and positioning of the third embodiment of FIG. 5 is realized in accordance with the second embodiment of FIG. 4.

What is claimed is:

1. A filter element of a filter for liquid, the filter element comprising:
a filter medium surrounding an element interior circumferentially continuously relative to a virtual axis of the filter element;
an end body connected to an end face of the filter element, wherein the end face is axial relative to the virtual axis;
wherein the end body comprises a filter element drainage opening surrounding the virtual axis and connected to the element interior;
wherein the end body further comprises at least one filter element sealing surface or filter element seal surface of a filter element sealing device, wherein the at least one filter element sealing surface or filter element seal surface surrounds the filter element drainage opening circumferentially continuously and is configured to close the filter element drainage opening when the filter element is mounted in the filter;
a seal of the filter element sealing device, wherein the seal is circumferentially continuous relative to the virtual axis and is fastened at the filter element.

2. The filter element according to claim 1, wherein the seal is configured to seal radially and/or axially relative to the virtual axis.

3. The filter element according to claim 1, further comprising a sleeve-shaped positioning element arranged at an exterior side of the end body and extending in an axial direction relative to the virtual axis away from the exterior side, wherein the sleeve-shaped positioning element is configured to form at least partially the filter element drainage opening, and wherein the seal is arranged at the sleeve-shaped positioning element.

4. The filter element according to claim 3, wherein the seal is arranged radially outwardly relative to the virtual axis at the sleeve-shaped positioning element.

5. The filter element according to claim 1, further comprising a sleeve fixedly connected to the end body and forming a discharge opening.

6. The filter element according to claim 5, wherein the sleeve is locked at the end body.

7. A discharge closure element for a discharge opening of a filter housing of a filter for liquid, wherein the discharge closure element is configured to connect to or to separate from a filter element and/or the filter housing by a rotary and/or insertion movement relative to a virtual axis of the filter element, the discharge closure element comprising:
at least one sealing surface of a filter element sealing device, wherein the at least one sealing surface is configured to close a filter element drainage opening of the filter element, wherein the filter element drainage opening surrounds the virtual axis circumferentially continuously, and is further configured to close the discharge opening;
wherein the at least one sealing surface is freely accessible in an axial direction from an end face of the discharge closure element, wherein the end face of the discharge closure element is axial relative to the virtual axis and, for closing the discharge opening, faces an interior of the filter housing.

8. The discharge closure element according to claim 7, wherein the at least one sealing surface is radially and/or axially oriented relative to the virtual axis.

9. The discharge closure element according to claim 7, further comprising a centering element configured to interact with a positioning element of the filter element, wherein the at least one sealing surface is arranged relative to the virtual axis radially inwardly or radially outwardly of the centering element.

10. The discharge closure element according to claim 7, further comprising a cover surface configured to close or open radially outer discharge openings of a bottom of a housing cover of the filter housing, wherein the radially outer discharge openings are configured to drain liquid from the filter housing.

11. A filter for liquid, the filter comprising:
a filter housing comprising a discharge opening for liquid;
a filter element arranged in the filter housing, wherein the filter element comprises:
a filter medium surrounding an element interior circumferentially continuously relative to a virtual axis of the filter element,
an end body connected to an end face of the filter element, wherein the end face is axial relative to the virtual axis,
wherein the end body comprises a filter element drainage opening surrounding the virtual axis and connected to the element interior,
wherein the end body further comprises at least one filter element sealing surface or filter element seal surface of a filter element sealing device, wherein the at least one filter element sealing surface or filter element seal surface surrounds the filter element drainage opening circumferentially continuously and is configured to close the filter element drainage opening when the filter element is mounted in the filter,
a seal of the filter element sealing device, wherein the seal is circumferentially continuous relative to the virtual axis and is fastened at the filter element;
a discharge closure element configured to connect to or to separate from the filter element and/or the filter housing by a rotary and/or insertion movement relative to the virtual axis of the filter element, the discharge closure element comprising:
at least one sealing surface of the filter element sealing device,
wherein the at least one sealing surface is configured to close the filter element drainage opening and is further configured to close the discharge opening,
wherein the at least one sealing surface is freely accessible in an axial direction from an end face of the discharge closure element, wherein the end face of the discharge closure element is axial relative to the virtual axis and, for closing the discharge opening, faces an interior of the filter housing.

12. The filter for liquid according to claim 11, wherein an axial expansion of a separation section of a housing cover of the filter housing is smaller than an axial expansion of the seal in the relaxed state, wherein, when axially compressing the seal, the separation section serves as a stop, wherein the inner diameter of the separation section is larger than an outer diameter of the seal.

13. The filter for liquid according to claim 11, wherein a positioning element of the filter element and the discharge closure element in the mounted state are arranged to overlap in axial direction, wherein a region of the discharge closure element surrounds a region of the positioning element or a region of the positioning element surrounds a region of the discharge closure element.
